(19) United States
(12) Patent Application Publication
(10) Pub. No.: US 2007/0211341 A1
(43) Pub. Date: Sep. 13, 2007

(54) Image scan apparatus, MFP and sub-scan magnification adjustment method

(75) Inventors: Yusuke Hashizume, Chiba-ken (JP); Hidetoshi Aoki, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/375,465

(22) Filed: Mar. 13, 2006

(51) Int. Cl. G02B 5/30

(52) U.S. Cl. 359/497

(57) ABSTRACT

An image scan apparatus includes a scanner including: a document table on which a document is placed; a carriage which scans a read area of an image; a stepping motor which moves the carriage; an image processing unit which processes an image signal resulted from scanning by the carriage; a scanner controller which performs a process necessary to read the image; and memory which stores information, wherein on the document table, a sub-scan magnification adjustment chart which expresses a predetermined shape in order to calculate an actual sub-scan magnification by the scanner controller is placed. According to the image scan apparatus, when error occurs in the actual sub-scan magnification, the sub-scan magnification can be automatically adjusted without an operator performing the adjustment work of the magnification in the sub-scanning direction.

### BACKGROUND OF THE INVENTION

1. Field of the Invention

The present invention relates to an image scan apparatus, MFP (Multi Function Peripherals) and a sub-scan magnification adjustment method, and particularly to an image scan apparatus, MFP and a sub-scan magnification adjustment method which automatically adjust the magnification in a sub-scanning direction.

2. Related Art

Heretofore, in an image scan apparatus, when an image of a document is read, the document is placed on a document table glass (contact glass), a carriage is moved in a sub-scanning direction, the carriage provided with a light source which irradiates light onto the document through the document table glass, and a photoelectric conversion element receives the light reflected from the document and converts it to an electric signal.

The magnification of the image to read in the sub-scanning direction is varied depending on the rate of travel of the carriage, etc. The rate of travel of the carriage is varied depending on the number of revolutions of a stepping motor which applies a drive force to the carriage, and the number of revolutions of the stepping motor is adjusted by the pitch of a pulse applied to the stepping motor. The dimensions of each of components of the image scan apparatus, such as the diameter of a drive shaft of the stepping motor, include error and the error is varied within a predetermined dimensional tolerance allowed for each of the components. Then, the dimension error of these components is accumulated to cause variations in the rate of travel of the carriage even though the number of revolutions is the same in the individual stepping motors.

On this account, as disclosed in a Publication of Japanese Patent Application JP-A-2003-69789 and a Publication of Japanese Patent Application JP-A-8-265560, an adjustment work of the magnification in the sub-scanning direction is performed as one of fabrication process steps of the image scan apparatus in which an operator compares an image of a test document with an image having read this test document, the difference in length therebetween is stored in a nonvolatile storage medium by the operator's manual operation, and data of the difference is the basis for the work.

Then, an image scan apparatus which eliminates the adjustment work of the magnification in the sub-scanning direction described above, MFP and a sub-scan magnification adjustment method are desired.

### SUMMARY OF THE INVENTION

The invention has been made in view of the circumstances. An object is to provide an image scan apparatus which eliminates an adjustment work of the magnification in a sub-scanning direction by an operator, MFP (Multi Function Peripherals) and a sub-scan magnification adjustment method.

An image scan apparatus according to the invention includes: a document table on which a document is placed to read an image; a carriage which scans a read area for the image; a stepping motor which moves the carriage; an image processing unit which processes an image signal resulted from scanning by the carriage; a scanner controller which performs a process necessary to read the image; and memory which stores information, wherein on the document table, a sub-scan magnification adjustment chart is placed which expresses a predetermined shape in order to calculate an actual sub-scan magnification by the scanner controller.

Further, an MFP according to the invention includes: a scanner which reads an image; and a printer which forms the image on paper, wherein the scanner includes: a document table on which a document is placed to read an image; a carriage which scans a read area for the image; a stepping motor which moves the carriage; an image processing unit which processes an image signal resulted from scanning by the carriage; a scanner controller which performs a process necessary to read the image; and memory which stores information, wherein on the document table, a sub-scan magnification adjustment chart is placed which expresses a predetermined shape in order to calculate an actual sub-scan magnification by the scanner controller.

According to the image scan apparatus and the MFP of the invention, when error occurs in the actual sub-scan magnification, the sub-scan magnification can be automatically adjusted without an operator performing the adjustment work of the magnification in the sub-scanning direction.

Further, a sub-scan magnification adjustment method according to the invention includes: reading an image of a sub-scan magnification adjustment chart at an initial position; reading the image of the sub-scan magnification adjustment chart at a position different from the initial position; calculating an actual sub-scan magnification based on the image of the sub-scan magnification adjustment chart read at the first chart image read step and the second chart image read step; and controlling a rate of a carriage in a sub-scanning direction which scans a read area of the image in case that the sub-scan magnification calculated at the sub-scan magnification detecting step is not 100%.

According to the sub-scan magnification adjustment method according to the invention, when error occurs in the actual sub-scan magnification, the sub-scan magnification can be automatically adjusted without an operator performing the adjustment work of the magnification in the sub-scanning direction.

### BRIEF DESCRIPTION OF THE DRAWINGS

In the accompanying drawings,

FIG. 1 is a diagram schematically illustrating the configuration of an image copying apparatus having an image scan apparatus (scanner) according to the invention;

FIG. 2 is a diagram schematically illustrating the configuration of the image scan apparatus according to the invention;

FIG. 3 is a diagram illustrative of a moving mechanism of a carriage of the image scan apparatus according to the invention;

FIG. 4 is a diagram illustrative of a control system of the image copying apparatus having the image scan apparatus according to the invention;

FIG. 5 is a diagram illustrating a top view and a side view of a document table of the image scan apparatus according to the invention, the views are shown as related to each other;

FIG. 6 is a diagram illustrative of the operation outline of a stepping motor of the image scan apparatus according to the invention;

FIG. 7 is a diagram illustrating an exemplary pulse to be applied to a motor driver of the stepping motor of the image scan apparatus according to the invention;

FIG. 8 is a diagram illustrating the relationship of a pixel in the main scanning direction between an image read position (reference point 0) before moved and an image read position (measurement point A) after moved when the image scan apparatus according to the invention is operated as its design value;

FIG. 9 is a diagram illustrating the relationship of a pixel in the main scanning direction between an image read position before moved and an image read position after moved when the magnification in the sub-scanning direction is smaller than the design value in the image scan apparatus according to the invention;

FIG. 10 is a diagram illustrating the relationship of a pixel in the main scanning direction between an image read position before moved and an image read position after moved when the magnification in the sub-scanning direction is greater than the design value in the image scan apparatus according to the invention;

FIG. 11 is a diagram illustrative of image profiling data resulted from scanning a sub-scan magnification adjustment chart in the image scan apparatus according to the invention; and

FIG. 12 is a flow chart illustrating a sub-scan magnification adjustment method according to the invention.

### DETAILED DESCRIPTION OF THE INVENTION

An embodiment of an image scan apparatus, MFP (Multi Function Peripherals) and a sub-scan magnification adjustment method according to the invention will be described with reference to the drawings.

It is to be noted that terms indicating directions such as “up or down”, “left or right” are used herein with reference to actually used state (including a state illustrated on the drawings) of the apparatus if there is no particular explanation.

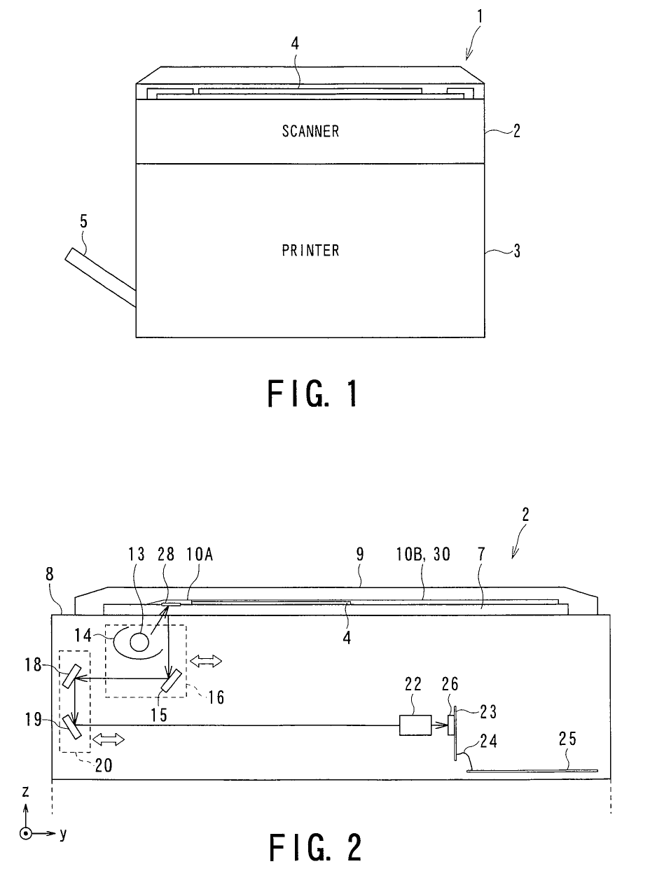

FIG. 1 is a diagram schematically illustrating the configuration of an image copying apparatus 1 having a scanner 2 which is an exemplary image scan apparatus according to the invention.

The image copying apparatus 1 has the scanner 2 which reads an image, and a printer 3 which forms the image on paper.

The scanner 2 reads (scans) a document 4 which is positioned to read the image. When the read image is formed, the scanner 2 transmits information about the read image to the printer 3.

The printer 3 forms the image on paper based on information about the image to be formed, and then outputs the paper on which the image is formed to a discharge tray 5.

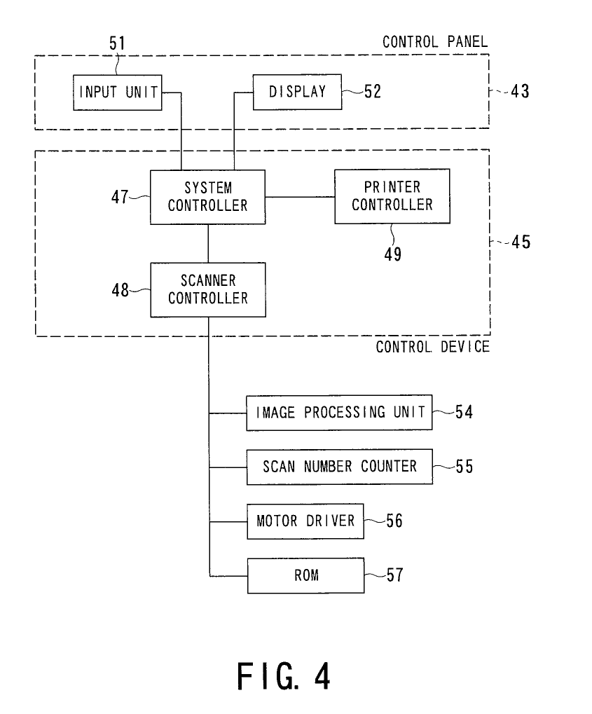

It is to be noted that the image copying apparatus 1 further has a system controller for control, and a control panel as a user interface, but they are omitted in FIG. 1 (see FIG. 4).

Further, the scanner 2 may not transmit information about the read image to the printer 3, and may transmit it to a recording apparatus etc., not shown.

furthermore, the information about the image to be formed by the printer 3 may be received from an apparatus, not shown, other than the scanner 2, or may be stored in the printer 3.

Next, the configuration and operation of the scanner 2 of the image copying apparatus 1 will be described.

FIG. 2 is a diagram schematically illustrating the configuration of the scanner 2 of the image copying apparatus 1.

Here, the y-axis direction shown in FIG. 2 indicates the sub-scanning direction, and the z-axis direction indicates the vertical direction. In addition, FIG. 2 shows the image copying apparatus 1 in the state in which the document 4 to be a target to read the image is set.

In the scanner 2, a document holding cover 9 is openablely and closablely provided to a casing 8 including a document table glass 7 as a document table.

The document table glass 7 is disposed on the top of the casing 8. Furthermore, on the document table glass 7, document scales 10A and 10B are mounted which show the positioning orientation and the document size of the document 4. In reading an image, the read surface of the document 4 to be a target to read an image is faced downward, and the document 4 is abutted against the document scales 10A and 10B on the document table glass 7 for positioning (in the case in which the positioning orientation is based on the corner).

The end of the document holding cover 9 is openably and closablely fixed to the casing 8, which presses the document 4 positioned on the document table glass 7 against the document table glass 7.

On the other hand, inside the casing 8, the following is provided: a first carriage 16 having a light source 13, a reflector 14 and a first mirror 15, a second carriage 20 having a second mirror 18 and a third mirror 19, a condenser lens 22, a CCD (Charge Coupled Device) sensor board 23 as a photoelectric conversion device, and a control board 25 as a scanner controller which is electrically connected to the CCD sensor board 23 through an electrical connecting unit such as a harness 24.

In the scanner 2 thus configured, in reading the image, light is first irradiated from the light source 13 onto the document 4, and is reflected at the document 4. The light reflected at the document 4 forms an image on the sensor surface of a CCD line sensor 26 as a photo-electric element which is mounted on the CCD sensor board 23 through the first mirror 15, the second mirror 18, the third mirror 19, and the condenser lens 22.

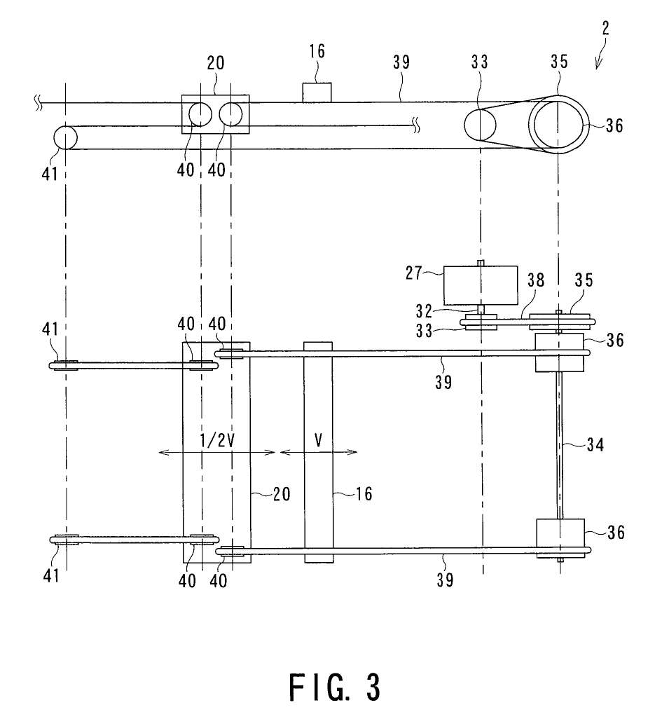

The first carriage 16 and the second carriage 20 are allowed to move in a sub-scanning direction (the y-axis direction shown in FIG. 2) by driving a motor 27, not shown in FIG. 2 (see FIG. 3). The first carriage 16 and the second carriage 20 are moved in the sub-scanning direction, and thus the light irradiated from the light source 13 scans.

Further, in the image copying apparatus 1, the optical path (light path) length from the original document 4 up to the CCD line sensor 26 is controlled to be constant by setting the moving speed of the first carriage 16 at twice the rate of travel (the moving speed) of the second carriage 20.

The CCD line sensor 26 successively reads the document 4 placed on the document table glass 7 at every line, and converts it to an analog electric signal corresponding to the intensity of a light signal as the reflected light. Then, the converted analog electric signal is transmitted to the control board 25 connected to the CCD sensor board 23 through the harness 24.

The control board 25 converts the analog electric signal received from the CCD line sensor 26 into a digital electric signal. Then, it performs digital signal processing such as shading (distortion) correction which corrects low frequency distortion due to the condenser lens 22, and high frequency distortion caused by sensitivity fluctuations due to the CCD line sensor 26.

When the shading correction is performed, a signal as a reference of black and a signal as a reference of white are required. The signal as the reference of black is an output signal of the CCD line sensor 26 when the light source 13 is placed into a switching-off state and in a state where light is not irradiated to the CCD line sensor 26. The signal as the reference of white is an output signal of the CCD line sensor 26 when the light source 13 is placed into a switching-on state and the reflected light from a white reference plate 28 is read.

Further, when the signals as the reference of black and white are generated, in order to reduce an influence due to a singular point or a quantization error, it is generally performed to average signals for plural lines.

A sub-scan magnification adjustment chart 30 is placed on the lower surface (the surface in contact with the document glass 7) side of the document scale 10B showing the size and dimensions of the document in the sub-scanning direction (hereinafter, referred to as a sub-scanning side document scale).

It is noted that the AD conversion processing performed in the control circuit board 25 may be performed in the CCD sensor board 23. Further, the CCD line sensor 26 may be another photoelectric device. Further, in some cases, the positioning of the document 4 is based on the center, other than the corner.

FIG. 3 is a diagram illustrating a moving mechanism of the first carriage 16 and the second carriage 20 in the scanner 2, wherein a top view seen from the document glass 7 side (upper side) and a side view are shown in association therewith.

The motor 27 is, for example, a stepping motor whose moving control is easy. A motor pulley 33 is attached to a rotating shaft 32 of the stepping motor 27. A reduction pulley 35 and take up pulleys 36 are attached to a shaft 34, which is a rotating shaft separate from the rotating shaft 32 of the stepping motor 27.

A drive force of the stepping motor 27 is transmitted to the reduction pulley 35 through a first wire 38 fitted to the motor pulley 33. The drive force transmitted to the reduction pulley 35 rotates two pairs of the take up pulleys 36 attached to the shaft 34 to loosen two pairs of second wires 39.

The first carriage 16 is fixed to the two pairs of the second wires 39 and therefore moves at a rate V which is the same as a rate of travel (moving speed) V of the second wires 39. On the other hand, the second carriage 20 is provided with a first idler pulley 40. By cooperation of the first pulley 40, a second pulley 41 and the take up pulley 36, the second carriage 20 moves in the manner similar to a moving pulley with respect to the movement of the second wires 39. That is, the moving speed of the second carriage 20 is ½ V, which is half of the moving speed V of the first carriage 16.

The moving speed of the first carriage 16 and the second carriage 20 generate error due to error (tolerances) caused by pulleys with a second wire 39 stretched, that is, a take up pulley 36, a first idler pulley 40 and a second idler pulley 41. The error of the rate of travel is a cause of the error in the magnification in the sub-scanning direction (hereinafter, it is the sub-scan magnification).

FIG. 4 is a diagram illustrative of a control system of the image copying apparatus 1.

The image copying apparatus 1 includes a control panel 43 as a user interface, the scanner 2, the printer 3, and a control device 45 which controls the control panel 43.

The control device 45 controls a system controller 47 which controls the overall apparatus, a scanner controller 48 which controls the scanner 2, and a printer controller 49 which controls the printer 3.

The system controller 47 is configured to transmit and receive information between the system controller 47 and the control panel 43 in which it receives information about input manipulation by a user from an input unit 51 of the control panel 43. Then, the system controller 47 recognizes the description requested by the user based on the received input information by the user.

Further, the system controller 47 transmits information to be provided for the user to the control panel 43, and can display the information to be provided on a display 52 of the control panel 43, for example.

The system controller 47 transmits and receives control information between it and the scanner controller 48 and the printer controller 49, and controls the operation of the scanner 2 and the printer 3 through the scanner controller 48 and the printer controller 49.

The scanner controller 48 controls the operation of the scanner 2. Therefore, a sub-scan magnification automatic adjustment process step which is one of the operations of the scanner 2 is controlled by the scanner controller 48.

The scanner controller 48 controls the operation of the CCD line sensor 26, and controls the CCD board 23 which processes an analog electric signal resulted from photoelectric conversion to transmit it to an image processing unit 54 at the subsequent stage, an image processing unit 54 which processes an image signal transmitted from the CCD board 23, a scan number counter 55 which counts the number of scans, and a motor driver 56 which drives the stepping motor 27.

Further, the scanner controller 48 can read information necessary to control the scanner 2 from ROM (Read Only Memory) 57. Set value information to control the stepping motor 27 is stored in the ROM 57.

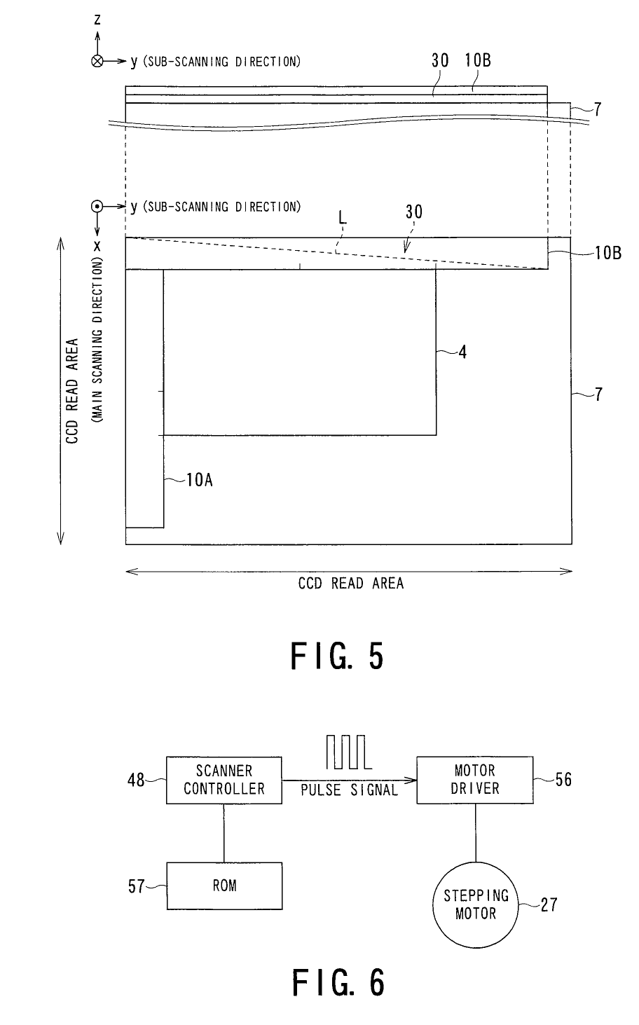

FIG. 5 is a diagram illustrating a top view and a side view of the document table of the scanner 2, the views are shown as related to each other.

As shown in FIG. 5, in the main scanning direction (the x-axis direction in FIG. 5) on the document table glass 7, the document scale (hereinafter, referred to as the main scanning side document scale) 10A is mounted which shows the document size and the dimensions in the main scanning direction. Furthermore, in the sub-scanning direction (the y-axis direction in FIG. 5), the sub-scanning side document scale 10B is mounted.

Further, a sub-scan magnification adjustment chart 30 which is placed on the lower surface side of the sub-scanning side document scale 10B, an oblique solid line (hereinafter, referred to as an oblique line) L, for example, is expressed on the surface on the document table glass 7 side. The shape of the oblique line L etc. expressed on the sub-scan magnification adjustment chart 30 is in the relationship that a single pixel in the main scanning direction is determined with respect to a single point in the sub-scanning direction.

The scanner 2 specifies the pixel on the main scan side that reads the oblique line L before and after the first carriage 16 and the second carriage 20 are moved, and automatically adjusts the sub-scan magnification in case that the actual sub-scan magnification that has error, which is calculated based on a result of scanning the sub-scan magnification adjustment chart 30.

It is noted that the main scanning side document scale 10A and the sub-scanning side document scale 10B may be configured integrally. Further, the sub-scan magnification adjustment chart 30 may be configured integrally as it is provided with the function of the sub-scanning side document scale 10B.

On the other hand, the sub-scan magnification adjustment chart 30 may be disposed on the lower surface of the document table glass 7 when the CCD line sensor 26 can be read. Further, the shape expressed on the sub-scan magnification adjustment chart 30 may be any shapes as long as its position can be specified based on the shape read by the CCD line sensor 26, not being limited to an oblique line L (it is in the relationship in which a single pixel in the main scanning direction is determined with respect to a single point in the sub-scanning direction).

Suppose that the shape expressed on the sub-scan magnification adjustment chart 30 is an oblique line L, there is an advantage that the error in the main scanning direction can be adopted as the error in the sub-scanning direction as it is.

Next, the operation of the image copying apparatus 1 will be described.

In the image copying apparatus 1, after the CCD line sensor 26 reads the shape on the sub-scan magnification adjustment chart 30, that is, the CCD line sensor 26 reads the image of the oblique line L at a given position at which the CCD line sensor 26 can read the oblique line L (upon completion of obtaining the image information), the first carriage 16 and the second carriage 20 moves the read position, and then the CCD line sensor 26 reads the image of the oblique line L. The image copying apparatus 1 detects the error of the sub-scan magnification based on the pixels on the main scan side that have read the image of the oblique line L at two different positions and information about the theoretical value stored in the ROM 57 beforehand, and automatically corrects the detected error.

FIG. 6 is a diagram illustrative of the operation outline of the stepping motor 27 which moves the carriages 16 and 20.

The number of revolutions (rotating speed) of the stepping motor 27 is controlled by a pulse signal which is transmitted from the scanner controller 48 to the motor driver 56.

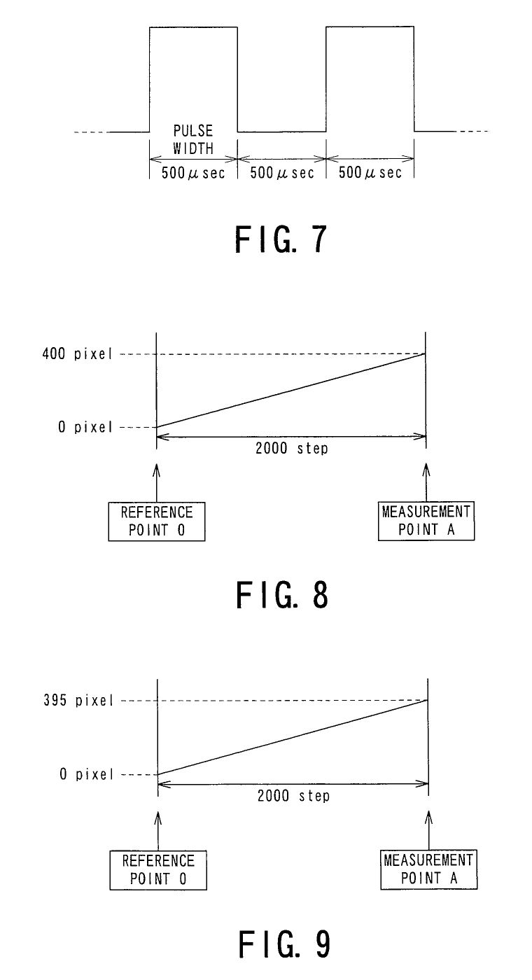

FIG. 7 is a diagram illustrating an exemplary pulse to be applied to the motor driver 56 of the stepping motor 27.

The number of revolutions of the stepping motor 27 and the pulse width are in the proportional relationship. The scanner controller 48 controls the pulse width inputted to the motor driver 56 to control the number of revolutions of the stepping motor 27.

The motor driver 56 variably drives the number of revolutions of the stepping motor 27 in accordance with the pulse width of the inputted pulse signal.

The ROM 57 is stored with information about the pulse width of a given reference pulse which is prepared as set value information to control the stepping motor 27 (for example, it is shown in FIG. 7).

The scanner controller 48 has a function that calculates the magnification in the sub-scanning direction and automatically adjusts it based on the calculated result.

The scanner controller 48 calculates the magnification in the sub-scanning direction based on two image signals which are processed by the image processing unit 54. Then, in the event that the magnification in the sub-scanning direction is not 100%, that is, when the error is detected in the rates of travel (the traveled distance for a fixed time period) of the first carriage 16 and the second carriage 20, a pulse signal is generated and transmitted to the motor driver 56, the pulse signal being varied in the pulse width with respect to the pulse width of the reference pulse so as to cancel (correct) the detected error.

Here, the concept of the error correction done by the scanner controller 48 will be described.

FIGS. 8 to 10 are diagrams illustrating the relationship of a pixel in the main scanning direction between the image read position before moved (reference point 0) and the image read position after moved (measurement point A).

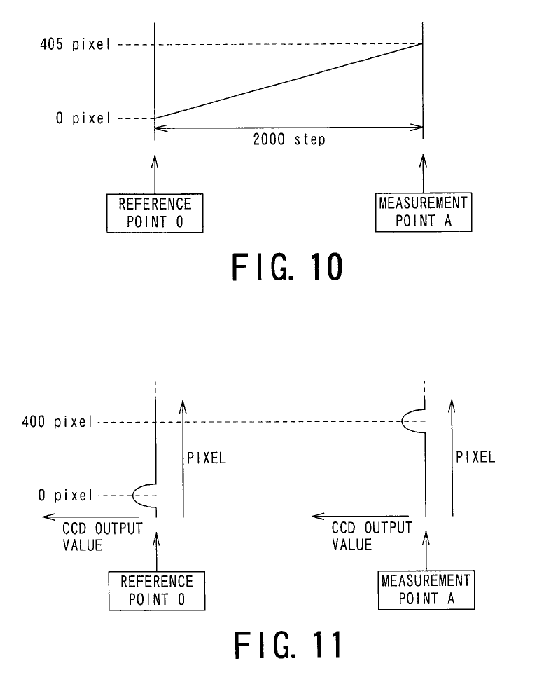

More specifically, FIG. 8 shows the case in which the apparatus is operated as the design value (reference value), FIG. 9 shows the case in which the sub-scan magnification is smaller than the design value (the traveled distance in the main scanning direction is smaller), and FIG. 10 shows the case in which the sub-scan magnification is greater than the design value (the traveled distance in the main scanning direction is greater).

In the event that the take up pulley 36, the first idler pulley 40 and the second idler pulley 41 have no error, for example, suppose that the relationship shown in FIG. 8 is held theoretically. More specifically, at the initial position (the reference point 0), the pixel in the main scanning direction that outputs the output value (hereinafter, referred to as the CCD output value) of the CCD line sensor 26 expressing the oblique line L is 0 pixel. In addition, when the first carriage 16 and the second carriage 20 are moved to a measurement point A in the sub-scanning direction by 200 mm (the distance corresponding to 2000 steps, for example), the traveled distance in the main scanning direction is about 16.93 mm and the pixel in the main scanning direction that outputs the CCD output value expressing the oblique line L is 400 pixels (the theoretical value) in the case in which the resolution is 600 dpi.

However, for example, when the diameter of the take up pulley 36 is smaller than the theoretical value, the traveled distance in the sub-scanning direction is shorter even though the stepping motor 27 is controlled at the same number of steps. Consequently, the traveled distance in the main scanning direction is also shorter than the theoretical value.

For example, as shown in FIG. 9, when the pixel in the main scanning direction that outputs the CCD output value expressing the oblique line L is 395 pixels, the traveled distance in the main scanning direction is 0.9875 times the theoretical value. Therefore, the actual traveled distance in the sub-scanning direction is also 0.9875 times the theoretical value, and the actual image read magnification is calculated as 98.75%.

In the case of the example shown in FIG. 9, the scanner controller 48 controls the pulse width to be 1/0.9875 (about 1.0127) times the pulse width of the reference pulse in order to correct the sub-scan magnification to 100%.

More specifically, the scanner controller 48 transmits to the motor driver 56 the pulse signal which modifies the pulse width so that the product of the pulse width and the sub-scan magnification is 1. When the pulse shown in FIG. 7 is the reference pulse, the pulse width of the reference pulse is 500 μsec (when the motor driver 56 detects the signal at the rise and fall of CLK), and thus it transmits to the motor driver 56 the pulse signal which modifies the pulse width at about 506.33 μsec.

On the contrary, when the diameter of the take up pulley 36 is greater than the theoretical value, the traveled distance in the sub-scanning direction is prolonged even though the stepping motor 27 is controlled at the same number of steps. Consequently, the traveled distance in the main scanning direction is longer than the theoretical value.

For example, as shown in FIG. 10, when the pixel in the main scanning direction that outputs the CCD output value expressing the oblique line L is 405 pixels, the traveled distance in the main scanning direction is 1.0125 times the theoretical value. Therefore, the actual traveled distance in the sub-scanning direction is also 1.0125 times the theoretical value, and the image read magnification in the actual sub-scanning direction can also be calculated as 101.25%.

In the case of the example shown in FIG. 10, the scanner controller 48 controls the pulse width to be 1/1.0125 (about 0.9877) times the pulse width of the reference pulse in order to correct the sub-scan magnification to 100%. Therefore, when the pulse shown in FIG. 7 is the reference pulse, the scanner controller 48 transmits to the motor driver 56 the pulse signal which modifies the pulse width of the reference pulse at about 493.83 μsec.

FIG. 11 is a diagram illustrative of the image profiling data of the oblique line L showing the relationship between the CCD output value resulted from scanning the sub-scan magnification adjustment chart 30 and the pixel in the main scanning direction.

The sub-scan magnification adjustment chart 30, for example, has a background in bright tone (the CCD output value is 255 or the value close to 255), and the oblique line L in dark tone (the CCD output value is 0 or the value close to 0). Therefore, in order to specify the pixel in the main scanning direction that outputs the CCD output value expressing the oblique line L, it is fine to scan the sub-scan magnification adjustment chart 30 to extract the pixel in the main scanning direction that has the CCD output value of 0 or the value close to 0.

The pixel extraction done to specify the pixel in the main scanning direction that outputs the CCD output value expressing the oblique line L is done by the image processing unit 54 shown in FIG. 4. The number of pixels extracted by the image processing unit 54 is adjusted properly in accordance with the thickness of the edge expressing the shape or resolution.

Next, a sub-scan magnification adjustment method according to the invention will be described.

The sub-scan magnification adjustment method according to the invention is done by using the image copying apparatus 1 provided with the scanner 2 in which the sub-scan magnification adjustment chart 30 is disposed on the document table glass 7, for example, as the image copying apparatus 1. The image copying apparatus 1 performs a sub-scan magnification automatic adjustment step to implement the sub-scan magnification adjustment method according to the invention.

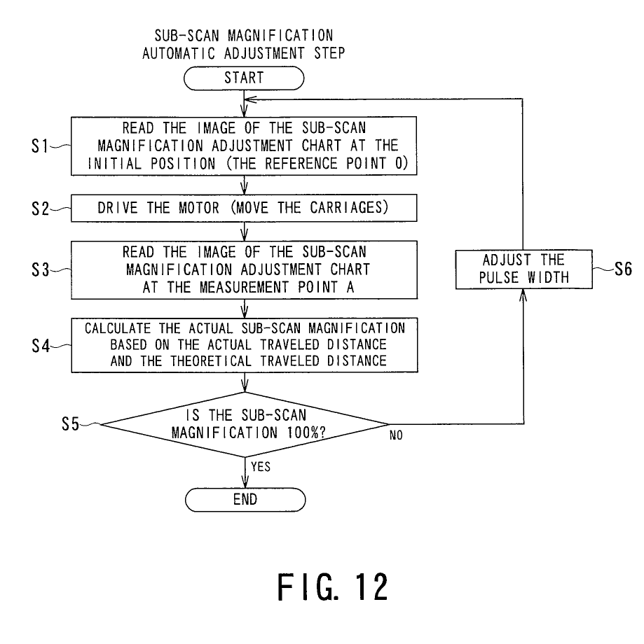

FIG. 12 is a flow chart illustrating the sub-scan magnification automatic adjustment step done by the image copying apparatus 1.

As shown in FIG. 12, the sub-scan magnification automatic adjustment step (step S1, step S3, step S4, and step S6) includes a first chart image read step (step S1) which reads the image of the sub-scan magnification adjustment chart 30 at the initial position (the reference point 0), a second chart image read step (step S3) which reads the image of the sub-scan magnification adjustment chart 30 at the position different from the initial position, a sub-scan magnification calculating step (step S4) which calculates the actual sub-scan magnification based on the image of the sub-scan magnification adjustment chart 30 read at the first chart image read step and the second chart image read step, and a carriage rate control step (step S6) which controls the rate of the carriage in the sub-scanning direction which scans the image read area when the sub-scan magnification calculated at the sub-scan magnification detecting step is not 100% (when NO at step S5).

At the sub-scan magnification automatic adjustment step, for example, when a user operates input and the system controller 47 receives a request to perform the sub-scan magnification automatic adjustment step from the control panel 43, the system controller 47 controls the scanner controller 48 to start the sub-scan magnification automatic adjustment step. Then, the scanner controller 48 starts the sub-scan magnification automatic adjustment step (START).

First, at step S1, the scanner 2 reads the image of the sub-scan magnification adjustment chart 30 at the initial position (the reference point 0). When the image read at the initial position is finished, the stepping motor 27 is driven to move the first carriage 16 and the second carriage 20 from the initial position (step S2). Then, the image of the sub-scan magnification adjustment chart 30 is read at the position after moved (step S3).

Subsequently, at step S4, the scanner controller 48 calculates the actual sub-scan magnification based on the image of the sub-scan magnification adjustment chart 30 read at the first chart image read step and the second chart image read step.

More specifically, the scanner controller 48 determines that the ratio of the actual traveled distance in which the stepping motor 27 is driven at a predetermined number of steps to move the first carriage 16 and the second carriage 20 from the initial position to the theoretical value.

The ratio of the actual traveled distance to the theoretical value can be understood as the ratio of the actual pixel in the main scanning direction that outputs the CCD output value expressing the oblique line L of the sub-scan magnification adjustment chart 30 to the pixel in the main scanning direction in theory.

When the actual sub-scan magnification calculated by the scanner controller 48 at step S4 is 100% (when YES at step S5), adjustment is unnecessary, and thus the sub-scan magnification automatic adjustment step is terminated.

On the other hand, when the actual sub-scan magnification calculated by the scanner controller 48 at step S4 is not 100% (when NO at step S5), the rates of travel of the first carriage 16 and the second carriage 20 are adjusted at step S6 in order to adjust the sub-scan magnification.

More specifically, the scanner controller 48 controls the pulse width of the pulse signal to be transmitted to the motor driver 56 to control the number of revolutions of the stepping motor 27, and thus the rates of travel of the first carriage 16 and the second carriage 20 are adjusted.

After the rates of travel of the first carriage 16 and the second carriage 20 are adjusted, the process returns from step S6 to step S1, and the process steps subsequent to step S1 are performed.

Although the sub-scan magnification automatic adjustment step is described as it is started when the scanner controller 47 receives the start request from the user, the sub-scan magnification automatic adjustment step may be started when the scanner controller 48 performs the process step which determines whether the number of scans at the scan number counter 55 reaches a predetermined number of scans and at the time when the number of scans indicated at the scan number counter 55 reaches a predetermined number of scans.

As described above, the sub-scan magnification automatic adjustment step is performed when the number of scans indicated at the scan number counter 55 reaches a predetermined number of scans, and thus the error that may be caused by the pulleys 36, 40 and 41 which are gradually worn when scanned can be periodically and automatically corrected.

As described above, according to the invention, the sub-scan magnification can be adjusted automatically, based on the image read at two different image read positions when the error occurs in the actual sub-scan magnification. Therefore, even though the operator does not perform the adjustment work of the magnification in the sub-scanning direction, the magnification in the sub-scanning direction can be maintained and adjusted correctly.

In the image copying apparatus 1, the scan number counter 55 and the scanner controller 48 are described as they are configured separately, but the scanner controller 48 may have the scan number counter 55.

Further, FIG. 1 shows the case of the image scan apparatus, but it is the same in the case of MFP which has the same image forming function as that of the image copying apparatus 1.

Moreover, the invention is not limited to each of the embodiments as they are not changed, and can be embodied as the components modified within the scope not deviating from the gist when applied.

What is claimed is:

1. An image scan apparatus comprising:
a document table on which a document is placed to read an image;
a carriage which scans a read area for the image;
a stepping motor which moves the carriage;
an image processing unit which processes an image signal resulted from scanning by the carriage;
a scanner controller which performs a process necessary to read the image; and
memory which stores information,
wherein on the document table, a sub-scan magnification adjustment chart which expresses a predetermined shape in order to calculate an actual sub-scan magnification by the scanner controller is placed.

2. The image scan apparatus according to claim 1, wherein said sub-scan magnification adjustment chart is placed outside an area to read an effective image.

3. The image scan apparatus according to claim 1, wherein said shape expressed on the sub-scan magnification adjustment chart is a linear line having a predetermined slope with respect to a sub-scanning direction.

4. The image scan apparatus according to claim 1, wherein said scanner controller has a function that calculates the sub-scan magnification and automatically adjusts a sub-scan magnification based on a calculated result.

5. The image scan apparatus according to claim 1, wherein said scanner controller is configured to control a rate of travel of the carriage such that the sub-scan magnification to be 100% in case that the sub-scan magnification, which is calculated based on images read at two different positions in the sub-scan magnification adjustment chart is not 100%.

6. The image scan apparatus according to claim 5, wherein said scanner controller is configured to calculate the sub-scan magnification when the scanner controller determines that the number of times to scan a read area of an image by the carriage reaches a predetermined number of times.

7. The image scan apparatus according to claim 5, wherein when the calculated sub-scan magnification is not 100%, said scanner controller is configured to adjust a pulse width of a pulse signal to be transmitted to a motor driver which drives the stepping motor to a reciprocal multiple of the sub-scan magnification calculated with respect to a pulse width of a pulse signal that is generated when the sub-scan magnification is 100%.

8. An MFP comprising:
a scanner which reads an image; and
a printer which forms the image on paper,
wherein said scanner includes:
a document table on which a document is placed to read an image;
a carriage which scans a read area for the image;
a stepping motor which moves the carriage;
an image processing unit which processes an image signal resulted from scanning by the carriage;
a scanner controller which performs a process necessary to read the image; and
memory which stores information,
wherein on the document table, a sub-scan magnification adjustment chart which expresses a predetermined shape in order to calculate an actual sub-scan magnification by the scanner controller is placed.

9. The MFP according to claim 8, wherein said sub-scan magnification adjustment chart is placed outside an area to read an effective image.

10. The MFP according to claim 8, wherein said shape expressed on the sub-scan magnification adjustment chart is a linear line having a predetermined slope with respect to a sub-scanning direction.

11. The MFP according to claim 8, wherein said scanner controller has a function that calculates the sub-scan magnification and automatically adjusts a sub-scan magnification based on a calculated result.

12. The MFP according to claim 8, wherein said scanner controller is configured to control a rate of travel of the carriage such that the sub-scan magnification to be 100% in case that the sub-scan magnification, which is calculated based on images read at two different positions in the sub-scan magnification adjustment chart is not 100%.

13. The MFP according to claim 12, wherein said scanner controller is configured to calculate the sub-scan magnification when the scanner controller determines that the number of times to scan a read area of an image by the carriage reaches a predetermined number of times.

14. The MFP according to claim 12, wherein when the calculated sub-scan magnification is not 100%, said scanner controller is configured to adjust a pulse width of a pulse signal to be transmitted to a motor driver which drives the stepping motor to a reciprocal multiple of the sub-scan magnification calculated with respect to a pulse width of a pulse signal that is generated when the sub-scan magnification is 100%.

15. A sub-scan magnification adjustment method comprising:
reading an image of a sub-scan magnification adjustment chart at an initial position;
reading the image of the sub-scan magnification adjustment chart at a position different from the initial position;
calculating an actual sub-scan magnification based on the image of the sub-scan magnification adjustment chart read at the first chart image read step and the second chart image read step; and
controlling a rate of a carriage in a sub-scanning direction which scans a read area of the image in case that the sub-scan magnification calculated at the sub-scan magnification detecting step is not 100%.

16. The sub-scan magnification adjustment method according to claim 15, further comprising determining whether the number of scans reaches a predetermined number of scans.

17. The sub-scan magnification adjustment method according to claim 15, wherein said carriage rate control step has:
adjusting a pulse width of a pulse signal transmitted to a motor driver based on a magnification calculated at the sub-scan magnification calculating step;
generating a pulse signal having a pulse width adjusted at the pulse width adjusting step; and
applying the pulse signal generated at the pulse signal generating step to the motor driver.
